(19) United States
(12) Patent Application Publication
(10) Pub. No.: US 2021/0153610 A1
(43) Pub. Date: May 27, 2021

(54) ZIPPER SLIDER SET

(71) Applicant: SINOX CO., LTD, New Taipei City (TW)

(72) Inventor: Yueh-Cheng HUANG, New Taipei City (TW)

(73) Assignee: SINOX CO., LTD, New Taipei City (TW)

(21) Appl. No.: 17/100,555

(22) Filed: Nov. 20, 2020

Related U.S. Application Data
(60) Provisional application No. 62/939,050, filed on Nov. 22, 2019.
(60) Provisional application No. 62/963,724, filed on Jan. 21, 2020.

(30) Foreign Application Priority Data
May 20, 2020 (TW) 109206209

(51) Int. Cl. A44B 19/30; A44B 19/26; A44B 19/06

(52) U.S. Cl. CPC A44B 19/301; A44B 19/06; A44B 19/262

(57) ABSTRACT

A zipper slider set is provided. The zipper slider set includes a first sliding device and a second sliding device. The first sliding device includes a first slider and a first puller having an engaging unit, wherein one end of the first puller is connected to the first slider. The second sliding device includes a second slider and a second puller having an engaging hole and an engaging device, wherein one end of the second puller is connected to the second slider. When the first slider and the second slider are in adjacent positions, the first puller can move to insert the engaging unit into the engaging hole and let the engaging device control the engaging and releasing of the engaging unit.

### BACKGROUND OF THE INVENTION

### 1. Field of the Invention

The present invention generally relates to a zipper slider set.

### 2. Description of the Prior Art

Users usually use zipper slider locks to lock the zippers of a case to secure their luggage while traveling. Wherein, the case could be but not limited to a suitcase or a briefcase. Conventionally, a zipper slider lock includes a combination lock or a key lock, and users can unlock the zipper slider lock to open the case by rotating at least one disc to the right combination or using a matching key.

On the other hand, the lockset can be further used in combination with a zipper of a box body. When the zipper is zipped up, a zipper puller can be inserted or clamped into a lock hole of the above lockset, and then a movable tenon member or button body in the lock hole of the above lockset can penetrate through a through hole of the zipper puller to achieve the locking effect. When it is opened, the lockset is unlocked at first, so that the tenon member or button body can be separated from the through hole of the zipper puller. The user can separate the zipper puller from the lock hole and pull the same apart to open the box body. However, since the lockset is located on the box body, the user must move the zipper puller close to the lockset for locking, and the operation is not convenient.

### SUMMARY OF THE INVENTION

An object of the present invention is to provide a zipper slider set which is more convenient to use. The zipper slider set includes a first sliding device and a second sliding device. The first sliding device includes a first slider and a first puller having an engaging unit, wherein one end of the first puller is connected to the first slider. The second sliding device includes a second slider and a second puller having an engaging hole and an engaging device, wherein one end of the second puller is connected to the second slider. When the first slider and the second slider are in adjacent positions, the first puller can move to insert the engaging unit into the engaging hole and let the engaging device control the engaging and releasing of the engaging unit.

In one embodiment, the second puller further includes a lock set, wherein the lock set can lock the engaging unit in the engaging hole when the engaging unit is inserted into the engaging hole.

In one embodiment, the lock set is a combination lock having number discs. The number discs and an opening are disposed at the other end of the second puller with respect to the end connected to the second slider. The opening exposes at least a portion of the number discs.

In one embodiment, the first puller further includes a first puller first side face and a first puller second side face disposed on opposite sides, wherein the engaging unit protrudes on the first puller second side face and is adjacent to the other end of the first puller with respect to the end connected to the first slider. The second puller further includes a second puller first side face and a second puller second side face disposed on opposite sides, wherein the engaging hole is disposed on the second puller first side face. The first puller can rotate to make the first puller second side face lean on the second puller first side face and insert the engaging unit into the engaging hole.

In one embodiment, the second puller first side face further has a concave part. When the first puller rotates to make the first puller second side face lean on the second puller first side face, at least a portion of the first puller is accommodated in the concave part to make the part of the second puller first side face except the concave part even with the first puller first side.

In one embodiment, the engaging unit has a hole. A tenon is disposed in the engaging hole. The tenon is movable to enter or exit the hole of the engaging unit. The engaging device can control the moving of the tenon to control the engaging and releasing of the engaging unit inserted into the engaging hole.

In one embodiment, the first puller further includes a first puller hole. The second slider further includes a second connecting part connected to the second puller. When the first puller rotates to make the first puller second side face lean on the second puller first side face, the second connecting part is accommodated in the first puller hole.

In one embodiment, the engaging hole is a through-hole.

In one embodiment, the engaging unit penetrates the second puller through the engaging hole.

In one embodiment, the first sliding device and the second sliding device are movably engaged with a zipper. An X-axis, a Y-axis, and a Z-axis are orthogonal to one another. The zipper is disposed on an X-Y plane and extends along the X-axis direction. The first puller can rotate along an X-Z plane with respect to the first slider. The second puller can rotate along the X-Z plane with respect to the second slider.

### BRIEF DESCRIPTION OF THE DRAWINGS

FIGS. 1 to 3 are schematic views of an embodiment of the present invention.

FIG. 4 is schematic views of an embodiment of the present invention, showing the engaging unit leaving the engaging hole.

FIG. 5 is schematic views of an embodiment of the present invention, showing the first sliding device and the second sliding device leaving each other.

FIGS. 6 to 10 are schematic views of another embodiment of the present invention.

FIGS. 11 to 15 are schematic views of another embodiment of the present invention.

### DETAILED DESCRIPTION OF THE PREFERRED EMBODIMENT

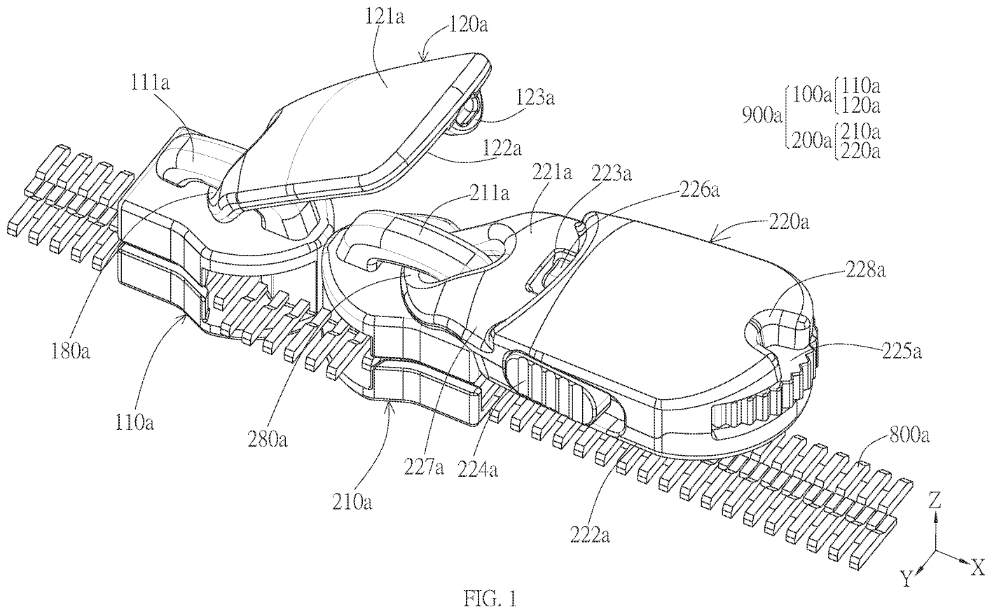

As shown in the embodiment in FIG. 1A, the zipper slider set 900a includes a first sliding device 100a and a second sliding device 200a. The first sliding device 100a includes a first slider 110a and a first puller 120a. One end of the first puller 120a is connected to the first slider 110a. The first puller 120a has an engaging unit 123a. The second sliding device 200a includes a second slider 210a and a second puller 220a. One end of the second puller 220a is connected to the second slider 210a. The second puller 220a includes an engaging hole 223s and an engaging device 224a. Specifically, the first sliding device 100a and the second sliding device 220a of the zipper slider set 900a are movably engaged with a zipper 800a. An X-axis, a Y-axis, and a Z-axis are orthogonal to one another. The zipper 800a is disposed on an X-Y plane and extends along the X-axis direction. The first puller 120a can rotate along an X-Z plane with respect to the first slider 110a. The second puller 220a can rotate along the X-Z plane with respect to the second slider 210a. In different embodiments, however, the first puller 120a and the second puller 220a can move in different ways or directions.

More particularly, as shown in the embodiments in FIGS. 1 to 3, the first puller 120a includes a first puller first side face 121a and a first puller second side face 122a. The first puller first side face 121a and the first puller second side face 122a are disposed on opposite sides of the first puller 120a. The engaging unit 123a protrudes on the first puller second side face 122a and is adjacent to the other end of the first puller 120a with respect to the end connected to the first slider 110a. The first slider 110a has a first connecting part 111a. One end of the first puller 120a has an annular part 180a. A portion of the annular part 180a is connected to the first connecting part 111a to make the first puller 120a rotatable with respect to the first slider 110a along the X-Z plane. The second puller 220a includes a second puller first side face 221a and a second puller second side face 222a. The second puller first side face 221a and the second puller second side face 222a are disposed on opposite sides. The engaging hole 223a is disposed on the second puller first side face 221a. The second slider 210a has a second connecting part 211a. One end of the second puller 220a is connected to the second connecting part 211a to make the second puller 220a rotatable with respect to the second slider 210a along the X-Z plane. Accordingly, the first puller 120a can rotate to make the first puller second side face 122a lean on the second puller first side face 221a and make the engaging unit 123a inserted into the engaging hole 223a.

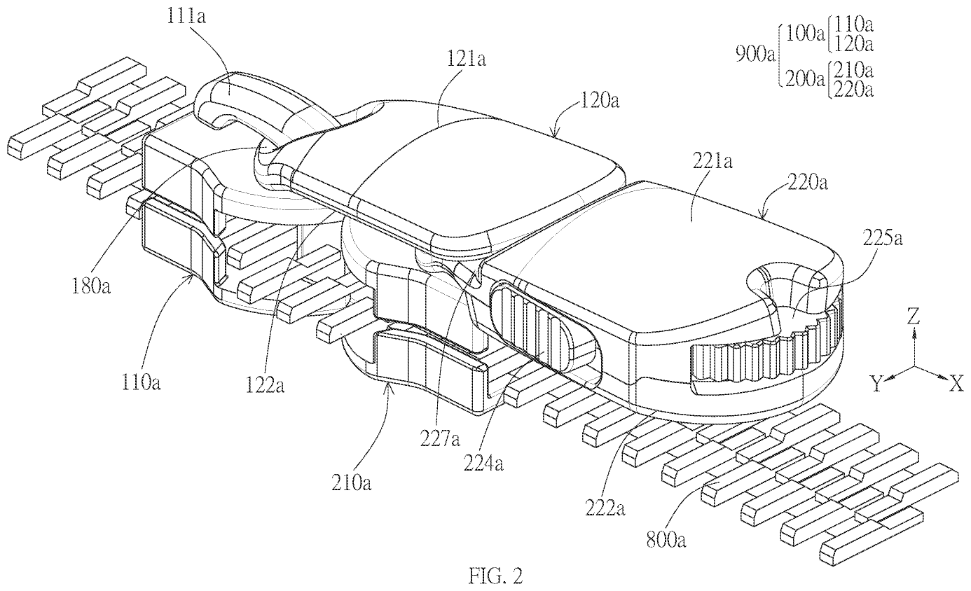

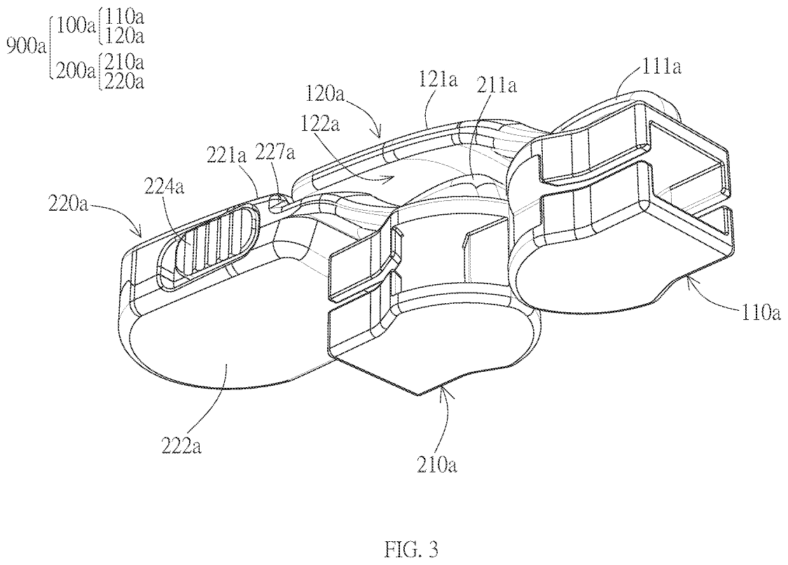

As shown in the embodiments in FIGS. 2 and 3, when the first slider 110a and the second slider 210a are in adjacent positions, the first puller 120a can move to allow the engaging unit 123a to be inserted into the engaging hole 223a and let the engaging device 224a control the engaging and releasing of the engaging unit 123a. As shown in the embodiment in FIG. 1, the engaging unit 123a has a hole. A tenon 226a is disposed in the engaging hole 223a, wherein the tenon 226a is movable to enter or exit the hole of the engaging unit 123a. The engaging device 224a can control the moving of the tenon 226a to control the engaging and releasing of the engaging unit 123a inserted into the engaging hole 223a. In different embodiments, however, the engaging unit 123a can be modified according to the manufacturing, design, and usage requirements. For example, the engaging unit 123a can be hooks or tongue pieces having dents, wherein the tenon 226a can be modified to accomplish engaging.

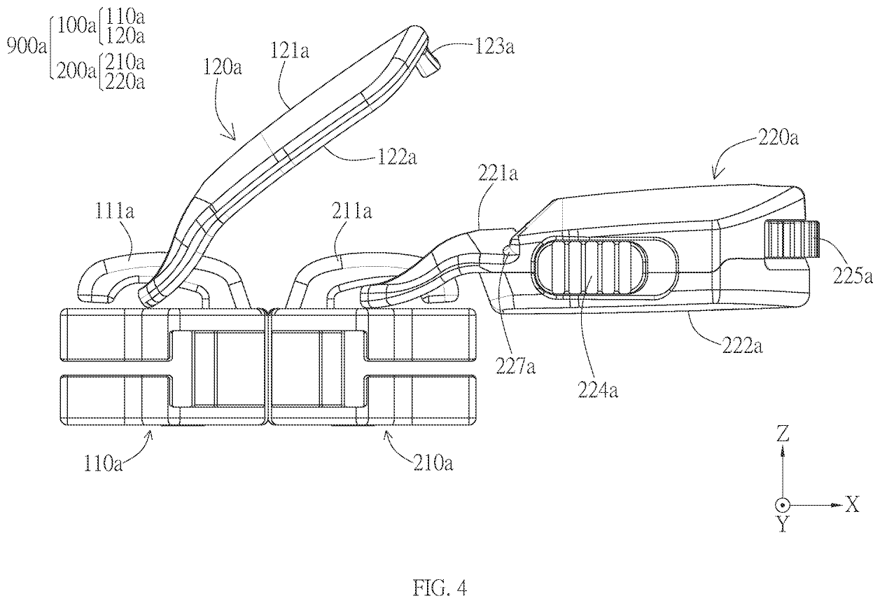

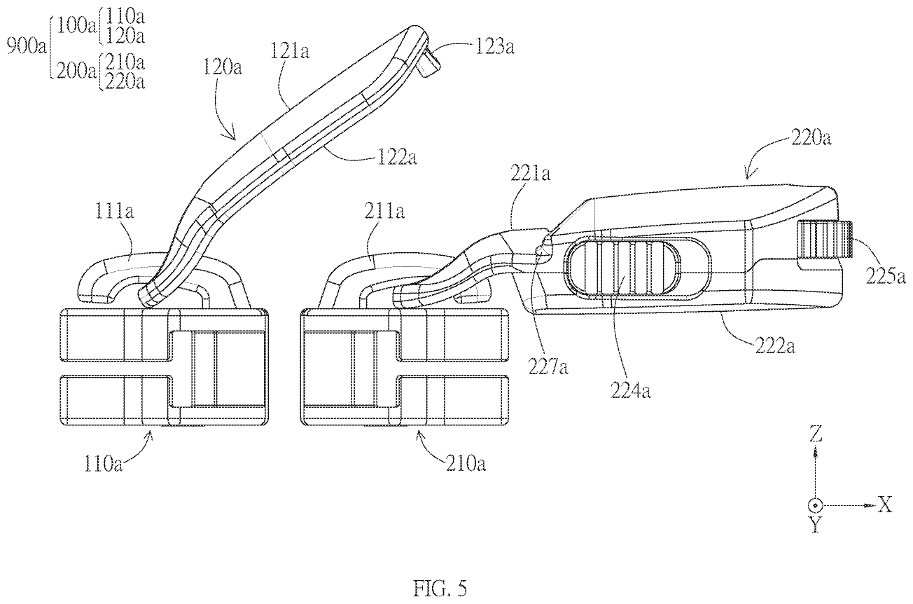

As shown in the embodiment in FIG. 2, when the first slider 110a and the second slider 210a are in adjacent positions and the first puller 120a moves to make the engaging unit 123a insert into the engaging hole 223a, the engaging device 224a can control and make the engaging unit 123a engage in the engaging hole 223a. Hence, it restricts the engaging unit 123a from leaving the engaging hole 223a and therefore restricts the first sliding device 100a and the second sliding device 200a from leaving each other. Thus, the zipper 800a is kept form opening. On the other hand, as shown in the embodiment in FIG. 4, the engaging device 224a can control and release the engaging unit 123a from the engaging hole 223a. In other words, the engaging unit 123a can leave the engaging hole 223a. At this time, as shown in the embodiment in FIG. 5, the first sliding device 100a and the second sliding device 200a can leave each other. Thus, the zipper 800a can be opened.

As shown in the embodiment in FIG. 1, the second puller 220a can include a lock set 225a. The lock set 225a can lock the engaging unit 123a in the engaging hole 223a when the engaging unit 123a inserts into the engaging hole 223a. From a different point of view, the first sliding device 100a can be locked on the second sliding device 200a, wherein the zipper slider set 900a as a whole can be seen as a zipper slider lock for locking and preventing the zipper 800a from opening. The lock set 225a is a combination lock having number discs, wherein the number discs and an opening 228a are disposed at the other end of the second puller 220a with respect to the end connected to the second slider 210a. The opening 228a exposes at least a portion of the number discs for the user to see the number discs to make the operation more convenient. In different embodiments, the lock set 225a can have a plurality of number discs or can be a different kind of lock other than a combination lock.

As shown in the embodiments in FIGS. 1 to 3, the second puller first side face 221a further has a concave part 227a. When the first puller 120a rotates to make the first puller second side face 122a lean on the second puller first side face 221a, at least a portion of the first puller 120a is accommodated in the concave part 227a to make the second puller first side face 221a except the concave part 227a even with the first puller first side 121a. From a different point of view, the second puller first side face 221a has a stage difference. The lower portion is the concave part 227a. The higher portion is even with the first puller first side 121a when the first puller second side face 122a leans on the second puller first side face 221a.

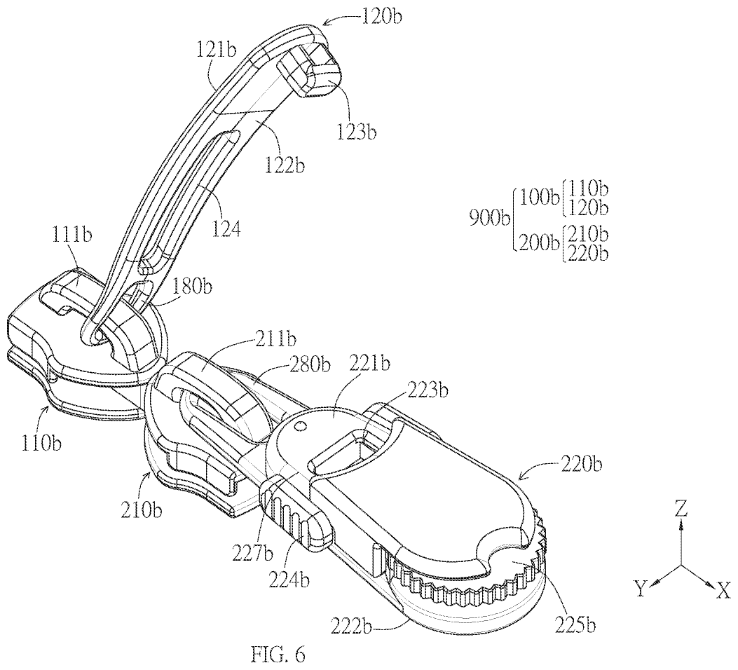

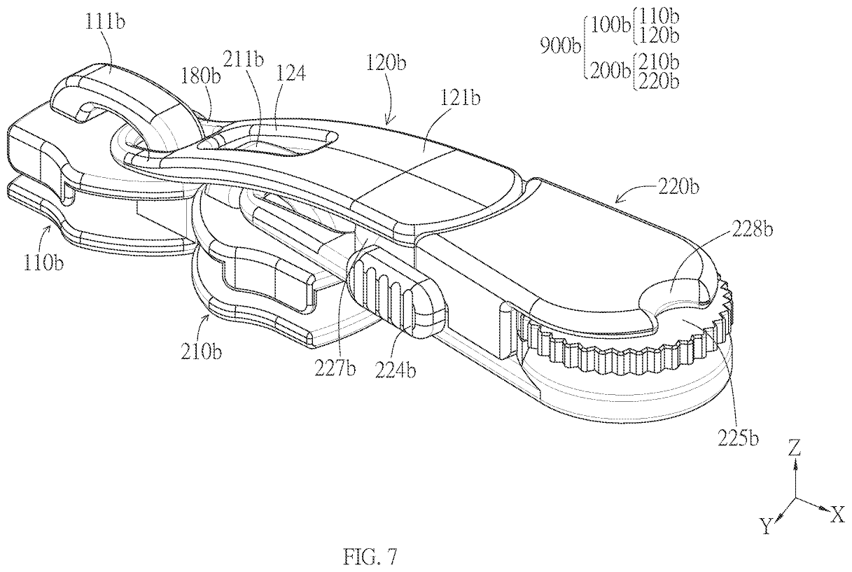

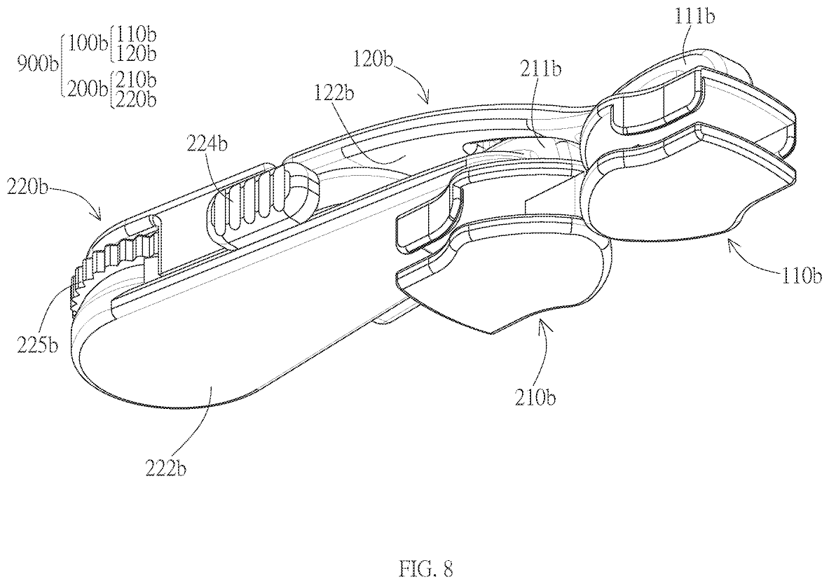

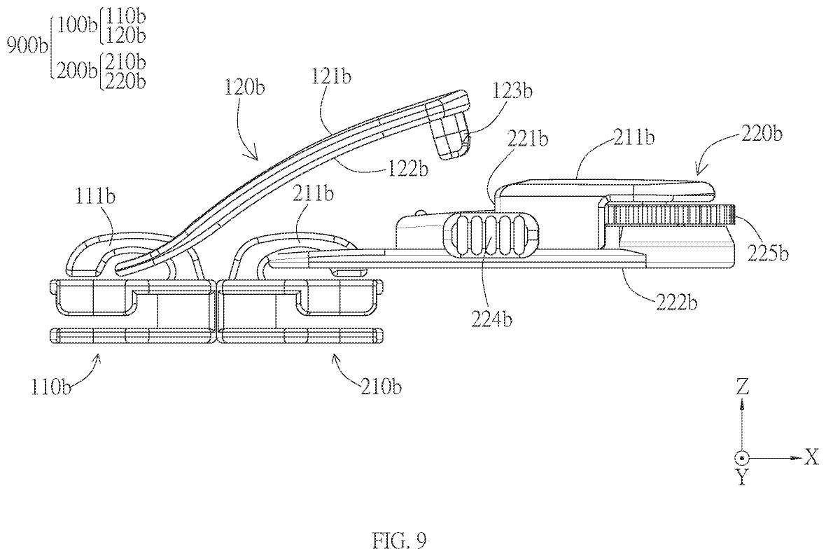

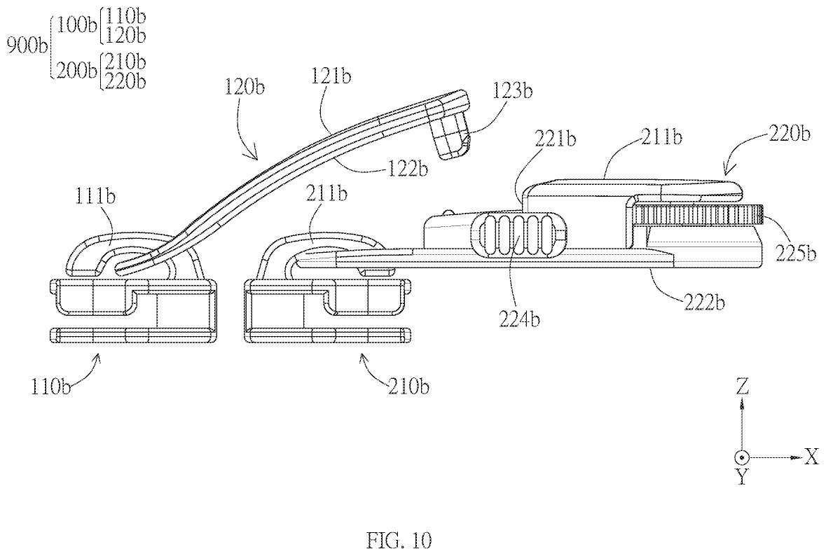

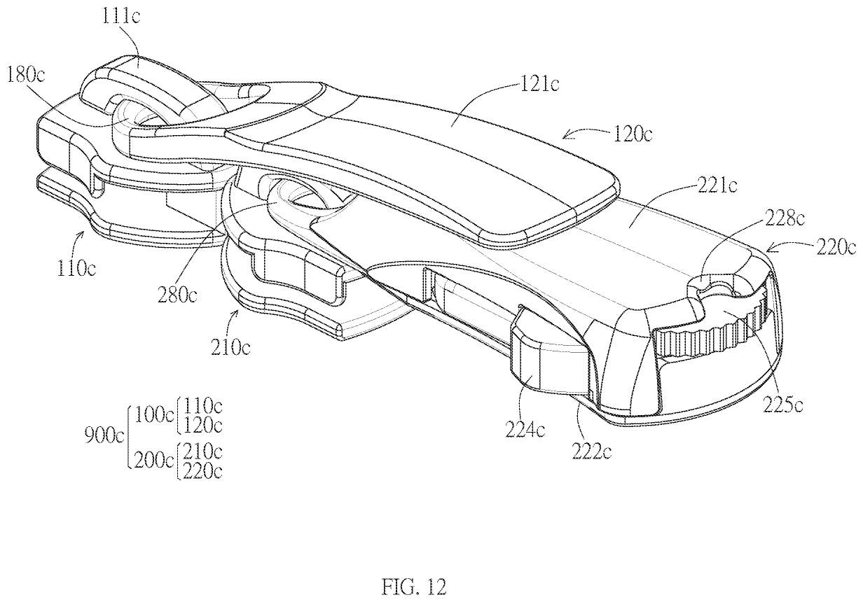

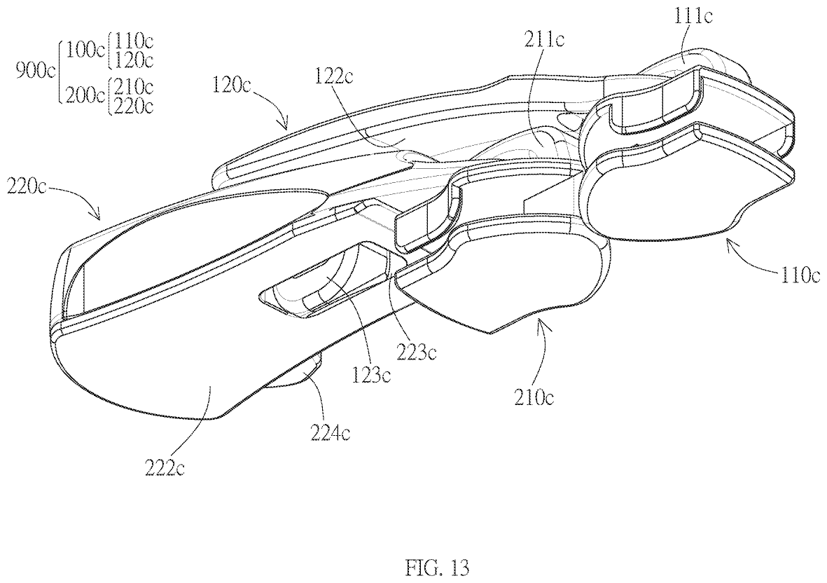

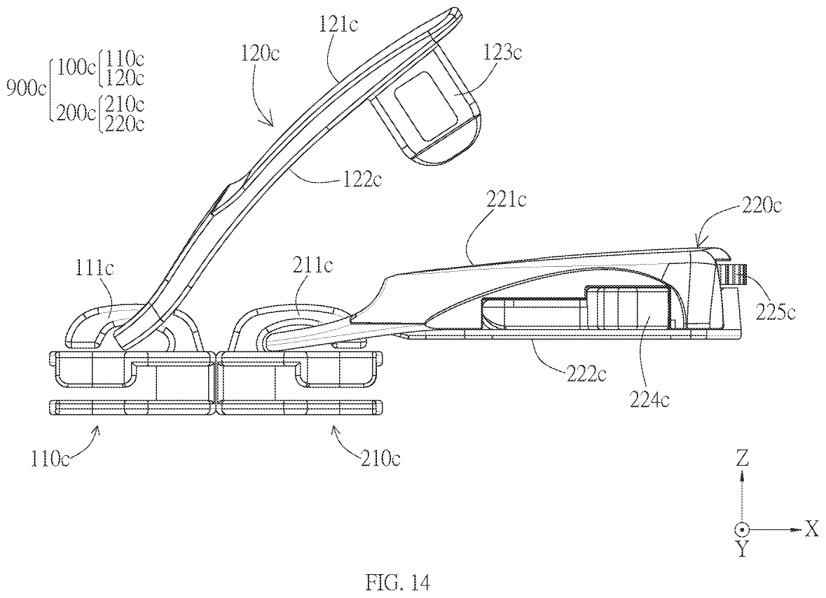

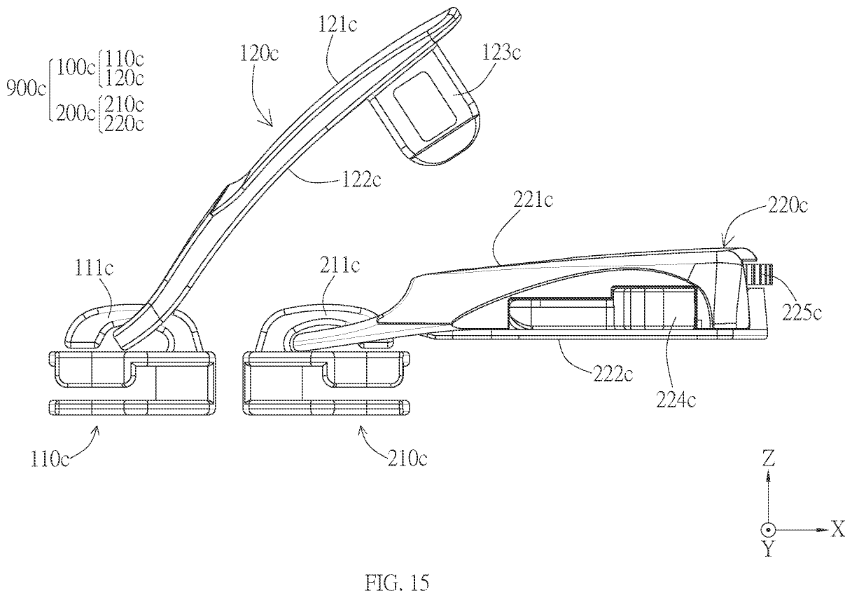

As shown in the embodiments in FIGS. 6 to 15, the first sliding device and the second sliding device can be modified according to the manufacturing, design, and usage requirements to form different zipper slider sets. As shown in the embodiments of zipper slider set 900b in FIGS. 6 to 10, the first puller 120b includes a first puller hole 124, wherein the second slider 210b includes a second connecting part 211b connected to the second puller 220b. As shown in the embodiment in FIG. 7, when the first puller 120b rotates to make the first puller second side face 122b lean on the second puller first side face 221b (see FIG. 6), the second connecting part 211b is accommodated in the first puller hole 124. Accordingly, when the first puller second side face 122b leans on the second puller first side face 221b, the hindrance to the second connecting part 211b can be reduced.

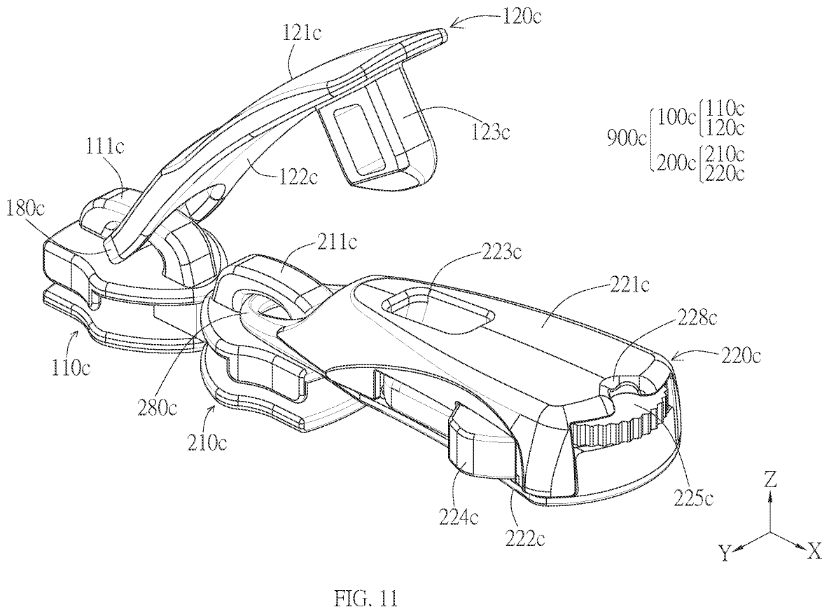

As shown in the embodiments of zipper slider set 900c in FIGS. 11 to 15, the engaging hole 223c is a through-hole. More particularly, engaging hole 223c penetrates the second puller 220c. In other words, the engaging hole 223c penetrates from the second puller first side face 221c to the second puller second side face 222c. The engaging unit 123c can penetrate the second puller t220c through the engaging hole 223c. Accordingly, larger engaging unit 123c having wider aperture to be engaged with the tenon in the engaging hole 223c more conveniently can be used.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A zipper slider set, comprising:
a first sliding device, including:
a first slider; and
a first puller having an engaging unit, wherein one end of the first puller is connected to the first slider;
a second sliding device, including:
a second slider; and
a second puller including an engaging hole and an engaging device,
wherein one end of the second puller is connected to the second slider;
when the first slider and the second slider are in adjacent positions, the first puller can move to insert the engaging unit into the engaging hole and let the engaging device control the engaging and releasing of the engaging unit.

2. The zipper slider set of claim 1, wherein the second puller further includes a lock set, the lock set can lock the engaging unit in the engaging hole when the engaging unit is inserted into the engaging hole.

3. The zipper slider set of claim 1, wherein the lock set is a combination lock having number discs, wherein the number discs and an opening are disposed at the other end of the second puller with respect to the end connected to the second slider, wherein the opening exposes at least a portion of the number discs.

4. The zipper slider set of claim 1, wherein:
the first puller further includes a first puller first side face and a first puller second side face disposed on opposite sides, wherein the engaging unit protrudes on the first puller second side face and is adjacent to the other end of the first puller with respect to the end connected to the first slider;
the second puller further includes a second puller first side face and a second puller second side face disposed on opposite sides, wherein the engaging hole is disposed on the second puller first side face;
the first puller can rotate to make the first puller second side face lean on the second puller first side face and insert the engaging unit into the engaging hole.

5. The zipper slider set of claim 4, wherein the second puller first side face further has a concave part, when the first puller rotates to make the first puller second side face lean on the second puller first side face, at least a portion of the first puller is accommodated in the concave part to make the part of the second puller first side face except the concave part even with the first puller first side.

6. The zipper slider set of claim 1, wherein the engaging unit has a hole, wherein a tenon is disposed in the engaging hole, wherein the tenon is movable to enter or exit the hole of the engaging unit, wherein the engaging device can control the moving of the tenon to control the engaging and releasing of the engaging unit inserted into the engaging hole.

7. The zipper slider set of claim 4, wherein:
the first puller further includes a first puller hole;
the second slider further includes a second connecting part connected to the second puller;
when the first puller rotates to make the first puller second side face lean on the second puller first side face, the second connecting part is accommodated in the first puller hole.

8. The zipper slider set of claim 1, wherein the engaging hole is a through-hole.

9. The zipper slider set of claim 8, wherein the engaging unit penetrates the second puller through the engaging hole.

10. The zipper slider set of claim 8, wherein:
the first sliding device and the second sliding device are movably engaged with a zipper;
an X-axis, a Y-axis, and a Z-axis are orthogonal to one another;
the zipper is disposed on an X-Y plane and extends along the X-axis direction;
the first puller can rotate along an X-Z plane with respect to the first slider;
the second puller can rotate along the X-Z plane with respect to the second slider.
